(19) United States
(12) Patent Application Publication
(10) Pub. No.: US 2023/0045715 A1
(43) Pub. Date: Feb. 9, 2023

(54) TEXT DETECTION METHOD, TEXT RECOGNITION METHOD AND APPARATUS

(71) Applicant: BEIJING BAIDU NETCOM SCIENCE TECHNOLOGY CO., LTD., Beijing (CN)

(72) Inventors: Chengquan ZHANG, Beijing (CN); Pengyuan LV, Beijing (CN); Sen FAN, Beijing (CN); Kun YAO, Beijing (CN); Junyu HAN, Beijing (CN); Jingtuo LIU, Beijing (CN)

(73) Assignee: BEIJING BAIDU NETCOM SCIENCE TECHNOLOGY CO., LTD., Beijing (CN)

(21) Appl. No.: 17/966,112

(22) Filed: Oct. 14, 2022

(30) Foreign Application Priority Data
Jan. 11, 2022 (CN) 2022100289603

(51) Int. Cl. G06V 30/19; G06V 30/16; G06V 30/14

(52) U.S. Cl. CPC G06V 30/19093; G06V 30/16; G06V 30/1444; G06V 30/19147

(57) ABSTRACT

The present disclosure provides a text detection method, a text recognition method and an apparatus, which relate to the field of artificial intelligence technology, in particular to the field of deep learning and computer vision technologies, and can be applied to scenarios such as optical character recognition. The text detection method is: acquiring an image feature of a text strip in a to-be-recognized image; performing visual enhancement processing on the to-be-recognized image to obtain an enhanced feature map of the to-be-recognized image; comparing the image feature of the text strip with the enhanced feature map for similarity to obtain a target bounding box of the text strip on the enhanced feature map.

### CROSS-REFERENCE TO RELATED APPLICATIONS

This application claims priority to Chinese Patent Application No. 202210028960.3, filed on Jan. 11, 2022, which is hereby incorporated by reference in its entirety.

### TECHNICAL FIELD

The present disclosure relates to the field of artificial intelligence technology, specifically to the field of deep learning and computer vision technologies, can be applied to scenarios such as optical character recognition (OCR), and in particular relates to a text detection method, a text recognition method and an apparatus.

### BACKGROUND

With the development and universal application of artificial intelligence technology, artificial recognition for an operation of recognizing text content in an image is gradually replaced with intelligent recognition, and determining a bounding box used to frame text content in the image is a pre-process of text content recognition.

In the prior art, a text detection method is usually based on an implementation of “artificial annotation+character prediction”, such as annotating a bounding box artificially, and predicting characters in the bounding box, so as to obtain text content corresponding to the text to be detected.

However, since artificial annotation is easily affected by human subjective factors, a technical problem of a low accuracy of text detection is resulted in.

### SUMMARY

The present disclosure provides a text detection method, a text recognition method and an apparatus.

According to a first aspect of the present disclosure, a text detection method is provided, including:

acquiring an image feature of a text strip in a to-be-recognized image; and performing visual enhancement processing on the to-be-recognized image to obtain an enhanced feature map of the to-be-recognized image, where the enhanced feature map is a feature map representing a feature vector of the to-be-recognized image;

comparing the image feature of the text strip with the enhanced feature map for similarity to obtain a target bounding box of the text strip on the enhanced feature map.

According to a second aspect of the present disclosure, a training method for a text detection model is provided, including:

acquiring image features of text strips in sample images; and performing visual enhancement processing on the sample images to obtain enhanced feature maps of the sample images, where the enhanced feature maps are feature maps representing feature vectors of the sample images;

comparing the image features of the text strips with the enhanced feature maps for similarity to obtain predicted bounding boxes of the text strips on the enhanced feature maps, and training a text detection model according to the predicted bounding boxes, where the text detection model is used to acquire a target bounding box of a to-be-recognized image.

According to a third aspect of the present disclosure, a text recognition method is provided, including:

acquiring a to-be-recognized image, and acquiring a bounding box of the to-be-recognized image, where the bounding box includes a text strip, and the bounding box is acquired based on the method according to the first aspect;

performing recognition processing on the bounding box to obtain text content of the to-be-recognized image.

According to a forth aspect of the present disclosure, a text recognition method is provided, including:

acquiring a to-be-recognized image, and acquiring a bounding box of the to-be-recognized image, where the bounding box includes a text strip, and the bounding box is acquired based on a preset text detection model, where the text detection model is generated by training based on the method according to the second aspect;

performing recognition processing on the bounding box to obtain text content of the to-be-recognized image.

According to a fifth aspect of the present disclosure, a text detection apparatus is provided, including:

at least one processor; and

a memory communicatively connected to the at least one processor; wherein,

the memory stores instructions executable by the at least one processor, and the instructions are executed by the at least one processor, to cause the at least one processor to:

acquire an image feature of a text strip in a to-be-recognized image;

perform visual enhancement processing on the to-be-recognized image to obtain an enhanced feature map of the to-be-recognized image, where the enhanced feature map is a feature map representing a feature vector of the to-be-recognized image;

compare the image feature of the text strip with the enhanced feature map for similarity to obtain a target bounding box of the text strip on the enhanced feature map.

According to a sixth aspect of the present disclosure, a training apparatus for a text detection model is provided, including:

at least one processor; and

a memory communicatively connected to the at least one processor; wherein,

the memory stores instructions executable by the at least one processor, and the instructions are executed by the at least one processor, to cause the at least one processor to execute the method according to the second aspect.

According to a seventh aspect of the present disclosure, a text recognition apparatus is provided, including:

at least one processor; and

a memory communicatively connected to the at least one processor; wherein,

the memory stores instructions executable by the at least one processor, and the instructions are executed by the at least one processor, to cause the at least one processor to:

acquire a to-be-recognized image;

acquire a bounding box of the to-be-recognized image, where the bounding box includes a text strip, and the bounding box is acquired based on the method according to the first aspect, or the bounding box is acquired based on a preset text detection model, where the text detection model is generated by training based on the following steps: acquiring image features of text strips in sample images; performing visual enhancement processing on the sample images to obtain enhanced feature maps of the sample images, wherein the enhanced feature maps are feature maps representing feature vectors of the sample images; comparing the image features of the text strips with the enhanced feature maps for similarity to obtain predicted bounding boxes of the text strips on the enhanced feature maps, and training a text detection model according to the predicted bounding boxes;

perform recognition processing on the bounding box to obtain text content of the to-be-recognized image.

It should be understood that the content described in this section is not intended to identify key or important features of embodiments of the present disclosure, nor is it intended to limit the scope of the present disclosure. Other features of the present disclosure will be easily understood through the following description.

### BRIEF DESCRIPTION OF DRAWINGS

The accompanying drawings are used to better understand the solutions, and do not constitute a limitation on the present disclosure. In the accompanying drawings:

FIG. 1 is a schematic diagram according to a first embodiment of the present disclosure.

FIG. 2 is a schematic diagram according to a second embodiment of the present disclosure.

FIG. 3 is a schematic diagram of a to-be-recognized image according to an embodiment of the present disclosure.

FIG. 4 is a schematic diagram according to a third embodiment of the present disclosure.

FIG. 5 is a schematic diagram according to a fourth embodiment of the present disclosure.

FIG. 6 is a schematic diagram according to a fifth embodiment of the present disclosure.

FIG. 7 is a schematic diagram according to a sixth embodiment of the present disclosure.

FIG. 8 is a schematic diagram according to a seventh embodiment of the present disclosure.

FIG. 9 is a schematic diagram according to an eighth embodiment of the present disclosure.

FIG. 10 is a schematic diagram according to a ninth embodiment of the present disclosure.

FIG. 11 is a schematic diagram of a tenth embodiment according to the present disclosure.

FIG. 12 is a schematic diagram according to an eleventh embodiment of the present disclosure.

FIG. 13 is a schematic diagram of a twelfth embodiment according to the present disclosure.

FIG. 14 is a block diagram of an electronic device used to implement a text detection method, a training method for a text detection model, and a text recognition method according to embodiments of the present disclosure.

### DESCRIPTION OF EMBODIMENTS

The following describes exemplary embodiments of the present disclosure in combination with the accompanying drawings, in which various details of the embodiments of the present disclosure are included to facilitate understanding, and shall be considered as merely exemplary. Therefore, those skilled in the art should realize that various changes and modifications can be made to the embodiments described herein without departing from the scope and spirit of the present disclosure. Similarly, for the sake of clarity and conciseness, the description of well-known functions and structures is omitted in the following.

A bounding box refers to a polygonal box, such as a rectangular box, used to frame text content in an image. In a scenario of recognizing text in an image or other recognition scenarios, it is usually necessary to determine a bounding box for framing a recognition object firstly, and then recognize content in the bounding box to obtain a recognition result.

For example, in the scenario of text recognition, a bounding box is determined firstly, and then text in the bounding box is recognized to obtain text content in the bounding box. For another example, in a scenario of recognizing a traffic light, a bounding box is determined firstly, and then a traffic light in the bounding box is recognized to determine whether the light is a red light, a green light or a yellow light. Since the application scenarios of the bounding box are relatively wide, and principles of applications of the bounding box in the scenarios are roughly the same, they will not be enumerated here.

Illustratively, there are two methods for determining a bounding box, one is a regression method and the other is a segmentation method.

The regression method is usually based on a manner of direct regression of network structure EAST (an Efficient and Accuracy Scenario Text detection pipeline) to obtain the bounding box.

However, when the regression method is used to determine a bounding box, due to that the method is easily limited by the receptive field ability of the network structure, boundary regression is relatively inaccurate especially in the case of long text or contaminated text, thereby resulting in a low detection accuracy of the bounding box of a text strip.

The segmentation method usually refers to define a text region, a non-text region, and a text boundary category threshold to distinguish the text region from the non-text region to obtain the bounding box.

However, when the segmentation method is used to determine the bounding box, if text overlaps, the overlapping text may not be separated in the text region effectively, thereby resulting in a technical problem that the detection of the bounding box may not distinguish the text accurately.

In order to avoid one or more of the above-mentioned technical problems, inventors of the present disclosure obtained the inventive concept of the present disclosure through creative work, which is: determining an image feature of a text strip of a to-be-recognized image, determining an enhanced feature map of the to-be-recognized image (a feature map obtained after performing visual enhancement processing on the to-be-recognized image), and determining a bounding box of the text strip from the enhanced feature map based on the image feature of the text strip and the enhanced feature map.

Based on the above inventive concept, the present disclosure provides a text detection method, a text recognition method and an apparatus, which are applied in the field of artificial intelligence technology, specifically in the field of deep learning and computer vision technologies, and can be applied to scenarios such as optical character recognition, so as to improve an accuracy and reliability of a detected bounding box.

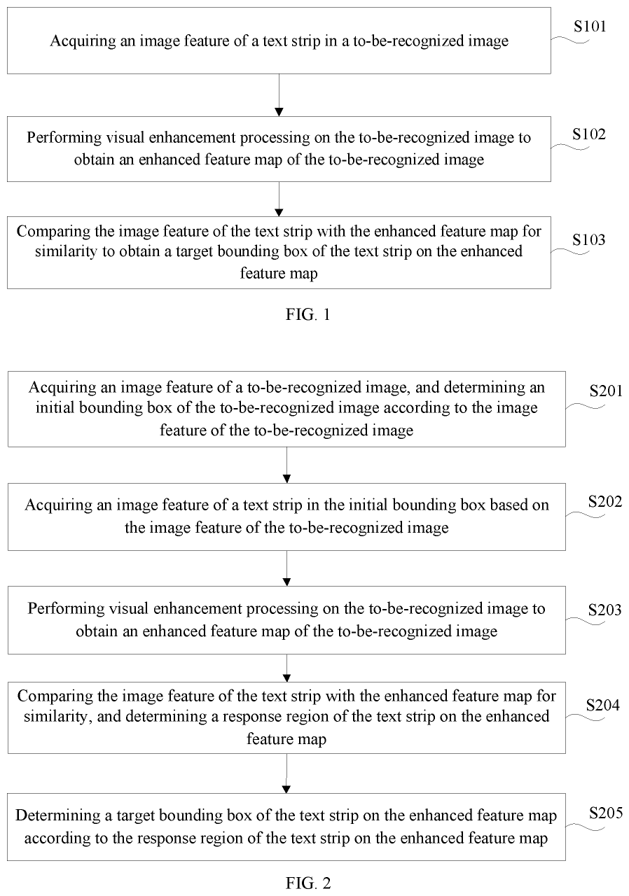

FIG. 1 is a schematic diagram according to a first embodiment of the present disclosure. As shown in FIG. 1, a text detection method provided by an embodiment of the present disclosure for improve an accuracy of text detection includes:

S101: acquiring an image feature of a text strip in a to-be-recognized image.

Illustratively, an executive entity of this embodiment may be a text detection apparatus (hereinafter referred to as a detection apparatus), and the detection apparatus may be a server (such as a local server or a cloud server), a computer, a terminal device, a processor, or a chip, etc., which is not limited in this embodiment.

A text strip may also be called a text line, which refers to a line that contains characters in the to-be-recognized image. The image feature of the text strip refers to a feature that represents color, texture, pixel, position of the text strip, etc.

S102: performing visual enhancement processing on the to-be-recognized image to obtain an enhanced feature map of the to-be-recognized image. The enhanced feature map is a feature map representing a feature vector of the to-be-recognized image.

It should be understood that there are various methods for the visual enhancement processing, and this embodiment does not limit the specific method used to perform visual enhancement processing on the to-be-recognized image. Relatively speaking, the enhanced feature map can represent the features of the to-be-recognized image (such as the features of the to-be-recognized image in color, texture, pixel, position, etc.) from more dimensions.

It is worth noted that there is no sequence limitation between the above S101 and S102, that is, the image feature of the text strip may be acquired firstly, and then the enhanced feature map may be acquired; or the enhanced feature map may be acquired firstly, and then the image feature of the text strip may be acquired; or the image feature of the text strip and the enhanced feature map may be acquired at the same time, which is not limited in this embodiment.

S103: comparing the image feature of the text strip with the enhanced feature map for similarity to obtain a target bounding box of the text strip on the enhanced feature map.

With the above analysis, the enhanced feature map can represent the features of the to-be-recognized image from more dimensions. Therefore, when the image feature of the text strip is compared with the enhanced feature map for similarity, the accuracy and reliability of the similarity comparison can be improved, and when the target bounding box of the text strip is determined from the enhanced feature map by an operation based on the similarity comparison, the accuracy and reliability of the determined target bounding box of the text strip can be improved.

Based on the above analysis, it can be known that the embodiment of the present disclosure provides a text detection method, including: acquiring the image feature of the text strip in the to-be-recognized image; performing visual enhancement processing on the to-be-recognized image to obtain the enhanced feature map of the to-be-recognized image, where the enhanced feature map is a feature map representing the feature vector of the to-be-recognized image; and comparing the image feature of the text strip with the enhanced feature map to obtain the target bounding box of the text strip on the enhanced feature map. In this embodiment, the technical feature of performing matching (i.e., similarity comparison) on the image feature of the text strip and the enhanced feature map after the two are acquired respectively to determine the bounding box of the text strip from the enhanced feature map is introduced. Since the enhanced feature map represents the feature of the to-be-recognized image from more dimensions, the determined bounding box can have higher accuracy and reliability. And the bounding box of the text strip is determined from the comparison similarity of the image feature of the text strip and the enhanced feature map, so that the bounding box can be determined from multiple dimensions to avoid a mismatch between the bounding box and the text strip. For example, the problem that the bounding box includes text strips that do not belong to the same line at the same time due to the inaccuracy of the bounding box can be avoided, so that the bounding box has the technical effect of strong pertinence and reliability.

FIG. 2 is a schematic diagram according to a second embodiment of the present disclosure. As shown in FIG. 2, a text detection method provided by an embodiment of the present disclosure includes:

S201: acquiring an image feature of a to-be-recognized image, and determining an initial bounding box of the to-be-recognized image according to the image feature of the to-be-recognized image. The initial bounding includes a text strip.

It should be noted that the technical features in this embodiment that are the same as those in the above embodiment are not described in detail in this embodiment. For example, the executive entity of this embodiment, the understanding of the text strip, the understanding of the image feature of the text strip and the like will not be enumerated here.

The to-be-recognized image may be an image inputted to a detection apparatus, or may be an image collected by the detection apparatus based on recognition requirements. This embodiment does not limit the method for acquiring the to-be-recognized image. For example:

in an example, the detection apparatus may be connected with an image collection apparatus, and receive the to-be-recognized image sent by the image collection apparatus;

in another example, the detection apparatus may provide a tool for loading images, and a user may transmit the to-be-recognized image to the detection apparatus through the tool for loading images.

The tool for loading images may be an interface for connecting with an external device, such as an interface for connecting with other storage device, through which the to-be-recognized image transmitted by the external device is obtained. The tool for loading images may also be a display apparatus. For example, the detection apparatus may output an interface with an image loading function on the display apparatus. The user may import the to-be-recognized image to the detection apparatus through the interface, and the detection apparatus acquires the imported to-be-recognized image.

The initial bounding box and a target bounding box are relative concepts. The initial bounding box may be understood as an approximate and rough bounding box of the to-be-recognized image acquired by the detection apparatus, that is, the accuracy of the initial bounding box is low, for example, a text strip in the initial bounding box are text strips in different lines. Compared with the initial bounding box, the target bounding box is relatively more accurate, and the frame selection of the text strip is more reliable.

This embodiment does not limit the implementation method of acquiring the image feature of the to-be-recognized image which, for example, can be implemented through a network structure in the related art, such as based on a network structure of a convolutional neural network (such as VGG, DenseNet), or based on a residual neural network (ResNet) structure, or based on a Vision Transformer network structure, which will not be enumerated here.

Similarly, this embodiment does not limit the method of acquiring the initial bounding box, which, for example, may be implemented through a network structure, such as a target positioning detection (region-based) network structure, and specifically, may be implemented through a structure of target positioning detection convolutional neural network (Faster-RCNN), which will not be enumerated here.

S202: acquiring an image feature of the text strip in the initial bounding box based on the image feature of the to-be-recognized image.

The number of initial bounding boxes may be multiple, and the number of text strips may also be multiple. Generally speaking, the number of initial bounding boxes is the same as the number of text strips. However, with the above analysis, since the initial bounding box is an approximate and rough bounding box, multiple text strips may be included in the initial bounding box at the same time.

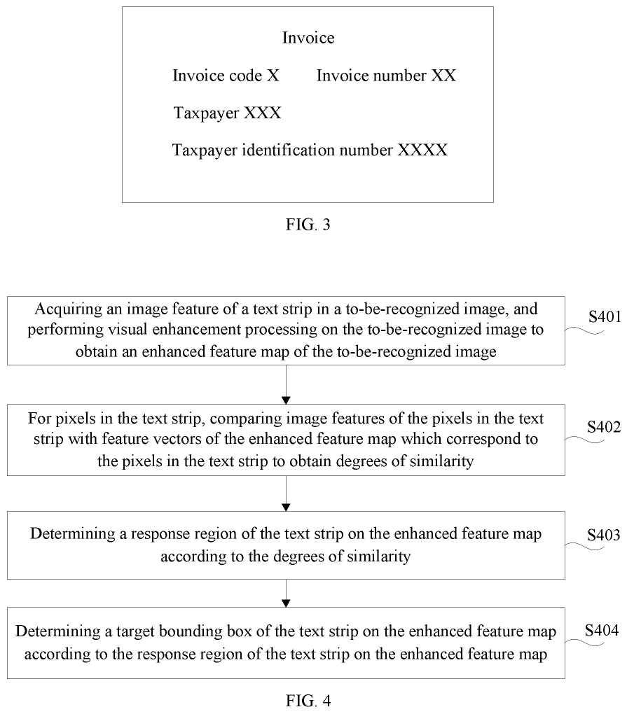

Taking an invoice as an example of the to-be-recognized image, please refer to FIG. 3 for the number of text strips. As shown in FIG. 3, the invoice includes: an invoice code X, an invoice number XX, a taxpayer XXX, a taxpayer identification number XXXX. Correspondingly, the number of text strips is four.

For each text strip, the image feature of each text strip is acquired based on the image feature of the to-be-recognized image.

In some embodiments, the feature of the text strip may be extracted based on an object detection (ROI pooling) method, so as to obtain the image feature of the text strip.

The image feature of the text strip may refer to a feature of a central pixel of the text strip, or an average feature of features of pixels in the text strip, or a pixel average value of the pixels in the text strip.

It should be understood that the above only takes an invoice as an example of the to-be-recognized image to illustrate the number of text strips, and should not be construed as a limitation on the number of text strips, nor a limitation on the to-be-recognized image.

The to-be-recognized image may be various images including text. For example, the to-be-recognized image may be an image of the education industry, such as images of books and test papers; for another example, the to-be-recognized image may also be an image of the financial industry, such as images of bills, etc.; for still another example, the to-be-recognized image may also be an image of the medical industry, such as images of medical record books; for yet another example, the to-be-recognized image may also be images of the transportation industry and the insurance industry, etc., which will not be enumerated here.

S203: performing visual enhancement processing on the to-be-recognized image to obtain an enhanced feature map of the to-be-recognized image. The enhanced feature map is a feature map representing a feature vector of the to-be-recognized image.

There is no necessary sequence relationship between acquiring the image feature of the text strip and acquiring the enhanced feature map, that is, the image feature of the text strip may be acquired first, or the enhanced feature map may be acquired first, or the image feature of the text strip and the enhanced feature map may be acquired at the same time.

In some embodiments, the visual enhancement processing may also be implemented based on the image feature of the to-be-recognized image.

Similarly, the enhanced feature map may also be acquired based on a network structure, which, for example, may be implemented by a feature pyramid (FPN) network structure, or by a deep supervision (U-Net) network structure, which will not be enumerated here.

S204: comparing the image feature of the text strip with the enhanced feature map for similarity, and determining a response region of the text strip on the enhanced feature map. The response region represents a position region of the text strip on the enhanced feature map.

Illustratively, the similarity comparison is a comparison of the degree of similarity of features, that is, a comparison of the degree of similarity between the image feature of the text strip and the enhanced feature map in terms of features, so as to determine the degree of similarity between the two.

Based on the above analysis, the number of text strips may be multiple, then when the number of text strips is multiple, for each text strip in the multiple text strips, the image feature of the text strip and the enhancement feature map are compared for similarity to determine a position region corresponding to the text strip on the enhanced feature map (the position region is called a response region, and in some embodiments, the response region may be highlighted). The position region may be one position region, such as one position region in unit of pixels, or may be multiple position regions. Generally, there are multiple position regions.

In some embodiments, the image feature of the text strip includes image features of pixels in the text strip, and the enhanced feature map includes feature vectors of pixels. S204 may include: comparing the image features of the pixels in the text strip with the feature vectors of the pixels in the enhanced feature map for similarity to obtain the response region of the text strip on the enhanced feature map.

For example, image features of pixels in text strips are represented by N*D, and feature vectors of the pixels in the enhanced feature map are represented by {H*W}*D, where N is the number of the text strips, H is the height of the to-be-recognized image, W is the width of the to-be-recognized image, and D is the dimension of the feature vectors.

By comparing the image features of the pixels in the text strips (N*D) and the feature vectors of the pixels in the enhanced feature map {H*W}*D for similarity, a response region of each of the N text strips on the enhanced feature map may be determined. Through the comparison of the two, the following technical effects can be achieved, i.e., the disadvantage of mixing in a pixel of other text strip is eliminated, the disadvantage of the bounding box containing overlapping text in the related art is avoided, and the accuracy and reliability of the target bounding box determined based on the response region are improved.

S205: determining a target bounding box of the text strip on the enhanced feature map according to the response region of the text strip on the enhanced feature map.

It is worth noted that, in this embodiment, the similarity comparison is realized based on the image feature of the text strip and the enhanced feature map, and the response region is determined on the enhanced feature map which has more features representing the to-be-recognized image. Therefore, compared with the initial bounding box, the determined target bounding box is determined based on richer features of the to-be-recognized image, which can frame the text strip more accurately, avoid the disadvantage of duplication between the text strips framed by respective target bounding boxes, and avoid the detection problem of overlapping text, so as to make the target bounding box have the technical effect of high accuracy and reliability.

FIG. 4 is a schematic diagram according to a third embodiment of the present disclosure. As shown in FIG. 4, a text detection method provided by an embodiment of the present disclosure includes:

S401: acquiring an image feature of a text strip in a to-be-recognized image, and performing visual enhancement processing on the to-be-recognized image to obtain an enhanced feature map of the to-be-recognized image. The enhanced feature map is a feature map representing a feature vector of the to-be-recognized image.

Similarly, the same technical features in this embodiment as those in the above embodiments will not be elaborated.

For the implementation principle of S401, reference may be made to the first embodiment or the second embodiment, which will not be repeated here.

S402: for pixels in the text strip, comparing image features of the pixels in the text strip with feature vectors of the enhanced feature map which correspond to the pixels in the text strip to obtain degrees of similarity.

The image feature of the text strip includes the image features of the pixels in the text strip; and the enhanced feature map includes the feature vectors of the pixels.

S403: determining a response region of the text strip on the enhanced feature map according to the degrees of similarity.

This embodiment may be understood as that the text strip includes multiple pixels. For each pixel in the multiple pixels, the image feature in the text strip for the pixel (that is, the image feature of the pixel in the text strip) and the feature vector of the pixel in the enhanced feature map are determined, and the above two are compared for similarity to obtain the degree of similarity between the image feature of the pixel in the text strip and the feature vector of the pixel in the enhanced feature map. By analogy, respective degrees of similarity corresponding to the pixels in the text strip are obtained, and the response region of the text strip is determined based on the degrees of similarity.

For example, for a pixel A, an image feature A1 of the pixel A in the text strip and a feature vector A2 of the pixel A in the enhanced feature map are determined, and A1 is compared with A2 for similarity to obtain a corresponding degree of similarity.

It should be noted that in this embodiment, by taking the pixels as a basis, the degrees of similarity between the image features in the text strip which correspond to the pixels and the feature vectors in the enhanced feature map which correspond to the pixels are determined to obtain the response region of the text strip, so as to realize the pertinence of the similarity comparison and achieve the technical effects of improving the accuracy and efficiency of the similarity comparison and thus improving the reliability and efficiency of determining the target bounding box.

In some embodiments, S403 may include the following steps.

The first step: determining a pixel whose degree of similarity is greater than a preset similarity threshold from the enhanced feature map according to the degrees of similarity.

The second step: determining the response region of the text strip on the enhanced feature map according to the determined pixel whose degree of similarity is greater than the preset similarity threshold.

Illustratively, with the above analysis, the number of the pixels in the text strip is multiple, and then for the multiple pixels, the degree of similarity between the image feature of each pixel in the text strip and the feature vector of the each pixel in the enhanced feature map is determined, that is, the degree of similarity corresponding to each pixel is obtained.

It should be noted that, in this embodiment, each degree of similarity is compared with the similarity threshold, such as determining whether each degree of similarity is greater than the similarity threshold. If a certain degree of similarity is greater than the similarity threshold, which means that the pixel corresponding to this degree of similarity is indeed a pixel of valid text in the text strip (the valid text refers to character content belonging to this text strip, that is, refers to text in which character content of other text strips is not mixed in), then the pixel is a valid text part in the target bounding box. Correspondingly, the degree of similarity greater than the similarity threshold is determined from the degrees of similarity, so as to determine the response region of the text strip by using the pixel corresponding to the determined degree of similarity greater than the similarity threshold, which can make the response region of the text strip be a valid response region, that is, a response region where text of other text strips is not mixed in. Thus when the target bounding box is determined based on the response region of the text strip, the text in the target bounding box can be all valid text, thereby achieving the technical effect of improving the accuracy and reliability of the target bounding box.

The similarity threshold may be set based on requirements, historical records, experiments and other ways, which is not limited in this embodiment.

For example, taking the determining of the similarity threshold according to a reliability requirement for the target bounding box as an example, for an application scenario where the reliability requirement for the target bounding box is relatively high, the similarity threshold may be set to a relatively large value; conversely, for an application scenarios where the reliability requirement for the target bounding box is relatively low, the similarity threshold may be set to a relatively small value.

In some embodiments, the pixel has a position attribute, and the second step may include: determining the response region of the text strip on the enhanced feature map according to the position attribute of the pixel whose degree of similarity is greater than the preset similarity threshold in the enhanced feature map.

The position attribute may be coordinates, that is, the coordinates of the pixel in the enhanced feature map, so as to determine the response region of the text strip by coordinates.

Correspondingly, when determining the target bounding box of the text strip according to the response region of the text strip, image connected component processing may be performed on the response region of the text strip to generate the target bounding box of the text strip.

It should be noted that in this embodiment, after the response region of the text strip is determined, an accurate outline of the text strip is extracted from the enhanced feature map, and the outline is the target bounding box of the text strip, so that the target bounding box of the text strip is highly fitted with the text strip, and non-valid text floating on the text of the text strip (such as a stamp floating on the text of the text strip in FIG. 3, not shown in the figure) is removed, achieving the technical effect of improving the accuracy, reliability and validity of the target bounding box.

S404: determining a target bounding box of the text strip on the enhanced feature map according to the response region of the text strip on the enhanced feature map.

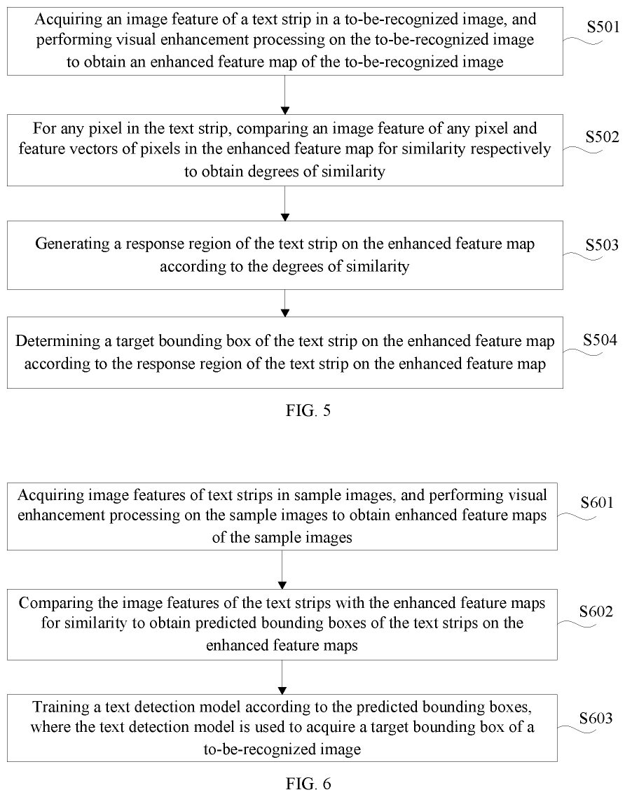

FIG. 5 is a schematic diagram according to a fourth embodiment of the present disclosure. As shown in FIG. 5, a text detection method provided by an embodiment of the present disclosure includes:

S501: acquiring an image feature of a text strip in a to-be-recognized image, and performing visual enhancement processing on the to-be-recognized image to obtain an enhanced feature map of the to-be-recognized image. The enhanced feature map is a feature map representing a feature vector of the to-be-recognized image.

Similarly, the same technical features in this embodiment as those in the above embodiments will not be elaborated.

For the implementation principle of S501, reference may be made to the first embodiment or the second embodiment, which will not be repeated here.

S502: for any pixel in the text strip, comparing an image feature of any pixel with feature vectors of pixels in the enhanced feature map for similarity respectively to obtain degrees of similarity.

The image feature of the text strip includes image features of pixels in the text strip; and the enhanced feature map includes feature vectors of the pixels.

S503: generating a response region of the text strip on the enhanced feature map according to the degrees of similarity.

This embodiment may be understood as that the text strip includes multiple pixels. For each pixel in the multiple pixels, the image feature in the text strip for this pixel (that is, the image feature of this pixel in the text strip) and the feature vector of each pixel in the enhanced feature map are determined, and the image feature of this pixel in the text strip is compared with the feature vector of each pixel in the enhanced feature map for similarity respectively to obtain degrees of similarity of this pixel. By analogy, respective degrees of similarity corresponding to each pixel in the text strip are obtained, and the response region of the text strip is determined based on the degrees of similarity.

For example, for a pixel A1, an image feature T1 of the pixel A1 in the text strip is determined, and the image feature T1 is compared with the feature vectors in the enhanced feature map for similarity respectively, so as to obtain multiple corresponding degrees of similarity.

For example, if the number of feature vectors in the enhanced feature image is B, the image feature T1 is compared with each of the B feature vectors for similarity to obtain B degrees of similarity.

Based on the above fourth embodiment, it can be known that in the fourth embodiment, a one-to-one similarity comparison is performed on the basis of the pixels. In this embodiment, a one-to-many similarity comparison is performed. Similarly, by performing similarity comparison in the manner of this embodiment, the accuracy and efficiency of similarity comparison can be improved, thereby achieving the technical effect of improving the reliability and efficiency of determining the target bounding box.

By performing similarity comparison based on the manner described in the fourth embodiment or the manner of this embodiment, the technical effect of improving flexibility and diversity of similarity comparison is realized.

In some embodiments, S503 may include the following steps.

The first step: determining a degree of similarity greater than a preset similarity threshold from the degrees of similarity, and determining, in the degree of similarity greater than the preset similarity threshold, a degree of similarity of the corresponding pixel in the text strip with the feature vector of the same pixel.

The second step: generating the response region of the text strip on the enhanced feature map according to the degree of similarity of the same pixel.

For example, in combination with the above example, for the image feature T1, B degrees of similarity are obtained by calculation. A degree of similarity greater than the similarity threshold is determined from the B degrees of similarity, and a degree of similarity of the pixel A1 in the enhanced feature map is determined from the degree of similarity greater than the similarity threshold, so as to determine the response region of the text strip in combination with the degree of similarity greater than the similarity threshold.

Similarly, through the solution of this embodiment, the response region of the text strip can be a valid response region, that is, a response region where text of other text strips is not mixed in, and thus when the target bounding box is determined based on the response region of the text strip, the text in the target bounding box can be all valid text, thereby achieving the technical effect of improving the accuracy and reliability of the target bounding box.

In some embodiments, the pixel has a position attribute, and the second step may include: determining the response region of the text strip on the enhanced feature map according to the position attribute of the same pixel in the enhanced feature map.

Correspondingly, when determining the target bounding box of the text strip according to the response region of the text strip, image connected component processing may be performed on the response region of the text strip to generate the target bounding box of the text strip.

It should be noted that in the embodiment, after the response region of the text strip is determined, an accurate outline of the text strip is extracted from the enhanced feature map, and the outline is the target bounding box of the text strip, so that the target bounding box of the text strip is highly fitted with the text strip, and non-valid text floating on the text of the text strip is removed, achieving the technical effect of improving the accuracy, reliability and validity of the target bounding box.

S504: determining a target bounding box of the text strip on the enhanced feature map according to the response region of the text strip on the enhanced feature map.

FIG. 6 is a schematic diagram according to a fifth embodiment of the present disclosure. As shown in FIG. 6, a training method for a text detection model provided by an embodiment of the present disclosure includes:

S601: acquiring image features of text strips in sample images, and performing visual enhancement processing on the sample images to obtain enhanced feature maps of the sample images. The enhanced feature maps are feature maps representing feature vectors of the sample images.

An executive entity of this embodiment may be a training apparatus for a text detection model (hereinafter referred to as a training apparatus), and the training apparatus may be the same apparatus as the detection apparatus in the above embodiments, or a different apparatus, which is not limited in this embodiment.

S602: comparing the image features of the text strips with the enhanced feature maps to obtain predicted bounding boxes of the text strips on the enhanced feature maps.

Illustratively, regarding the implementation principle of acquiring the predicted bounding boxes in this embodiment, reference may be made to the implementation principle of acquiring the target bounding box in the above embodiments, which will not be repeated in this embodiment.

In some embodiments, S602 may include the following steps.

The first step: comparing the image features of the text strips with the enhanced feature maps for similarity to determine response regions of the text strips on the enhanced feature maps, where the response regions represent position regions of the text strips on the enhanced feature maps.

In some embodiments, an image feature of a text strip includes image features of pixels in the text strip, and an enhanced feature map includes feature vectors of the pixels. The first step may include: comparing image features of pixels in the text strips with feature vectors of the pixels in the enhanced feature maps for similarity to obtain the response regions of the text strips on the enhanced feature maps.

In an example, for the pixels in the text strip, the image features of the pixels in the text strip are compared with the feature vectors of the enhanced feature map which correspond to the pixels in the text strip to obtain degrees of similarity, and the response region of the text strip on the enhanced feature map is determined according to the degrees of similarity.

For example, a pixel whose degree of similarity is greater than a preset similarity threshold is determined from the enhanced feature map according to the degrees of similarity, and the response region of the text strip on the enhanced feature map is determined according to the determined pixel whose degree of similarity is greater than the preset similarity threshold.

The pixel has a position attribute, and the response region of the text strip on the enhanced feature map may be determined according to the position attribute of the pixel whose degree of similarity is greater than the preset similarity threshold in the enhanced feature map.

Correspondingly, image connected component processing may be performed on the response region of the text strip to generate a target bounding box of the text strip.

In another example, for any pixel in the text strip, the image feature of any pixel is compared with the feature vectors of the pixels in the enhanced feature map for similarity respectively to obtain respective degrees of similarity, and the response region of the text strip on the enhanced feature map is generated according to the degrees of similarity.

For example, a degree of similarity greater than a preset similarity threshold is determined from the degrees of similarity. A degree of similarity of the corresponding pixel in the text strip with the feature vector of the same pixel is determined in the degree of similarity greater than the preset similarity threshold. The response region of the text strip on the enhanced feature map is generated according to the degree of similarity of the same pixel.

The pixel has a position attribute, and the response region of the text strip on the enhanced feature map may be determined according to the position attribute of the same pixel in the enhanced feature map.

Correspondingly, image connected component processing may be performed on the response region of the text strip to generate a target bounding box of the text strip on the enhanced feature map.

The second step: determining predicted bounding boxes of the text strips on the enhanced feature maps according to the response regions of the text strips on the enhanced feature maps.

S603: training a text detection model according to the predicted bounding boxes, where the text detection model is used to acquire a target bounding box of a to-be-recognized image.

Illustratively, with the above analysis, the predicted bounding boxes may be obtained based on various network structures. Correspondingly, a network structure may be trained based on the predicted bounding boxes to adjust parameters of the network structure, thereby a text detection model is obtained.

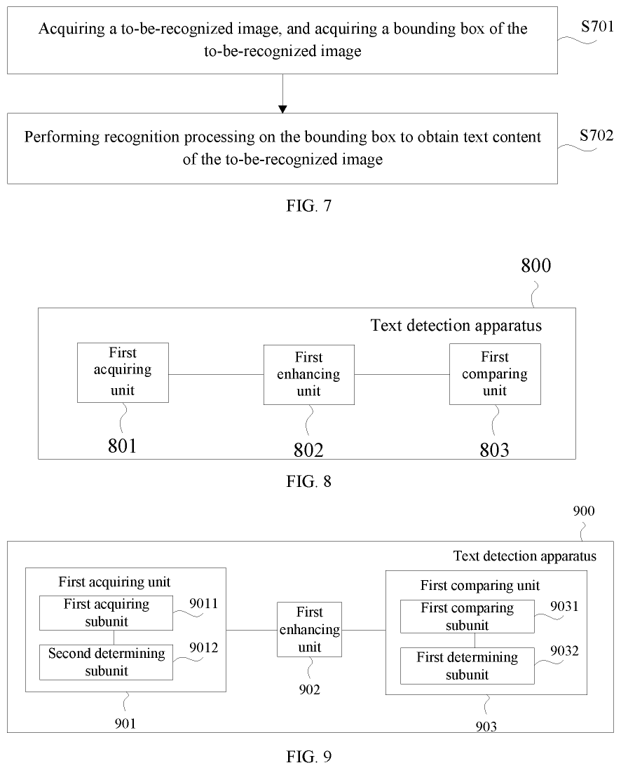

FIG. 7 is a schematic diagram according to a sixth embodiment of the present disclosure. As shown in FIG. 7, a text recognition method provided by an embodiment of the present disclosure includes:

S701: acquiring a to-be-recognized image, and acquiring a bounding box of the to-be-recognized image. The bounding box includes a text strip, and the bounding box is acquired based on the methods described in the first to fourth embodiments, or the bounding box is acquired based on a preset text detection model, and the text detection model is generated by training based on the method described in the fifth embodiment.

S702: performing recognition processing on the bounding box to obtain text content of the to-be-recognized image.

Based on the above analysis, the determined bounding box has high accuracy and reliability. Thus, when performing the recognition processing on the bounding box, the technical effect of improving the flexibility and accuracy of recognition can be achieved.

FIG. 8 is a schematic diagram according to a seventh embodiment of the present disclosure. As shown in FIG. 8, a text detection apparatus 800 provided by an embodiment of the present disclosure includes:

a first acquiring unit 801, configured to acquire an image feature of a text strip in a to-be-recognized image;

a first enhancing unit 802, configured to perform visual enhancement processing on the to-be-recognized image to obtain an enhanced feature map of the to-be-recognized image, where the enhanced feature map is a feature map representing a feature vector of the to-be-recognized image;

a first comparing unit 803, configured to compare the image feature of the text strip with the enhanced feature map for similarity to obtain a target bounding box of the text strip on the enhanced feature map.

FIG. 9 is a schematic diagram according to an eighth embodiment of the present disclosure. As shown in the FIG. 9, a text detection apparatus 900 provided by an embodiment of the present disclosure includes:

a first acquiring unit 901, configured to acquire an image feature of a text strip in a to-be-recognized image.

With reference to FIG. 9, in some embodiments, the first acquiring unit 901 includes:

a first acquiring subunit 9011, configured to acquire an image feature of the to-be-recognized image.

a second determining subunit 9012, configured to determine an initial bounding box of the to-be-recognized image according to the image feature of the to-be-recognized image, where the initial bounding includes the text strip.

A first enhancing unit 902 is configured to perform visual enhancement processing on the to-be-recognized image to obtain an enhanced feature map of the to-be-recognized image, where the enhanced feature map is a feature map representing a feature vector of the to-be-recognized image.

A first comparing unit 903, is configured to compare the image feature of the text strip with the enhanced feature map for similarity to obtain a target bounding box of the text strip on the enhanced feature map.

With reference to FIG. 9, in some embodiments, the first comparing unit 903 includes:

a first comparing subunit 9031, configured to compare the image feature of the text strip with the enhanced feature map for similarity to determine a response region of the text strip on the enhanced feature map, where the response region represents a position region of the text strip on the enhanced feature map;

a first determining subunit 9032, configured to determine the target bounding box of the text strip on the enhanced feature map according to the response region of the text strip on the enhanced feature map.

In some embodiments, the image feature of the text strip includes image features of pixels in the text strip, and the enhanced feature map includes feature vectors of pixels. The first comparing subunit 9031 is configured to compare the image features of the pixels in the text strip with the feature vectors of the pixels in the enhanced feature map for similarity to obtain the response region of the text strip on the enhanced feature map.

In some embodiments, the first comparing subunit 9031 includes:

a first comparing module, configured to, for the pixels in the text strip, compare the image features of the pixels in the text strip with the feature vectors of the enhanced feature map which correspond to the pixels in the text strip to obtain degrees of similarity;

a first determining module, configured to determine the response region of the text strip on the enhanced feature map according to the degrees of similarity.

In some embodiments, the first determining module includes:

a first determining sub-module, configured to determine a pixel whose degree of similarity is greater than a preset similarity threshold from the enhanced feature map according to the degrees of similarity;

a second determining sub-module, configured to determine the response region of the text strip on the enhanced feature map according to the determined pixel whose degree of similarity is greater than the preset similarity threshold.

In some embodiments, the pixel has a position attribute. The second determining sub-module is configured to determine the response region of the text strip on the enhanced feature map according to the position attribute of the pixel whose degree of similarity is greater than the preset similarity threshold in the enhanced feature map.

And the first determining subunit 9032 is configured to perform image connected component processing on the response region of the text strip to generate the target bounding box of the text strip.

In other embodiments, the first comparing subunit 9031 includes:

a second comparing module, configured to, for any pixel in the text strip, compare an image feature of any pixel with the feature vectors of the pixels in the enhanced feature map for similarity respectively to obtain degrees of similarity;

a first generating module, configured to generate the response region of the text strip on the enhanced feature map according to the degrees of similarity.

In some embodiments, the first generating module includes:

a third determining sub-module, configured to determine a degree of similarity greater than a preset similarity threshold from the degrees of similarity;

a fourth determining sub-module, configured to determine, in the degree of similarity greater than the preset similarity threshold, a degree of similarity of the corresponding pixel in the text strip with the feature vector of the same pixel;

a first generating sub-module, configured to generate the response region of the text strip on the enhanced feature map according to the degree of similarity of the same pixel.

In some embodiments, the pixel has a position attribute. The first generating sub-module is configured to determine the response region of the text strip on the enhanced feature map according to the position attribute of the same pixel in the enhanced feature map.

And the first determining subunit 9032 is configured to perform image connected component processing on the response region of the text strip to generate the target bounding box of the text strip on the enhanced feature map.

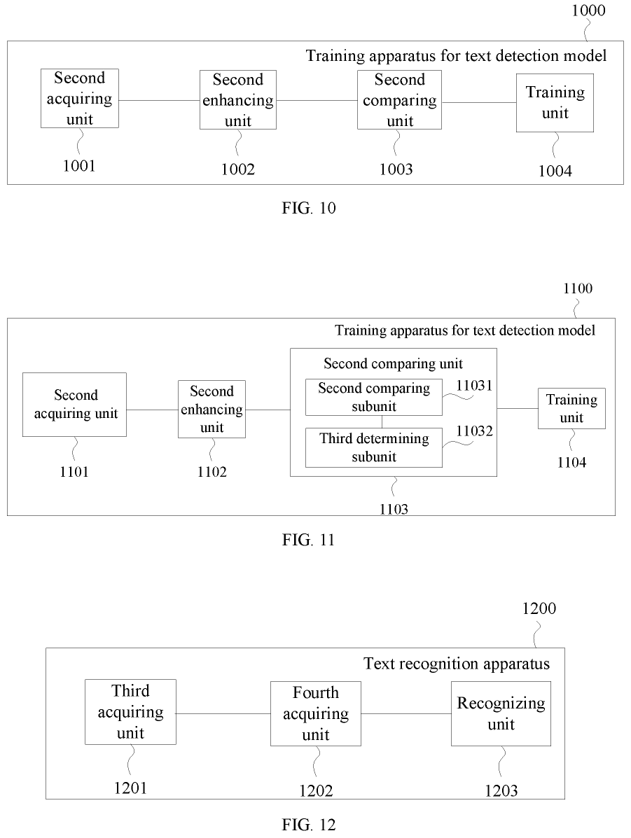

FIG. 10 is a schematic diagram according to a ninth embodiment of the present disclosure. As shown in the figure, a training apparatus 1000 for a text detection model provided by an embodiment of the present disclosure includes:

a second acquiring unit 1001, configured to acquire image features of text strips in sample images;

a second enhancing unit 1002, configured to perform visual enhancement processing on the sample images to obtain enhanced feature maps of the sample images, where the enhanced feature maps are feature maps representing feature vectors of the sample images;

a second comparing unit 1003, configured to compare the image features of the text strips with the enhanced feature maps to obtain predicted bounding boxes of the text strips on the enhanced feature maps;

a training unit 1004, configured to train a text detection model according to the predicted bounding boxes, where the text detection model is used to acquire a target bounding box of a to-be-recognized image.

FIG. 11 is a schematic diagram according to a tenth embodiment of the present disclosure. As shown in FIG. 11, a training apparatus 1100 for a text detection model provided by an embodiment of the present disclosure includes:

a second acquisition unit 1101, configured to acquire image features of text strips in sample images;

a second enhancing unit 1102, configured to perform visual enhancement processing on the sample images to obtain enhanced feature maps of the sample images, where the enhanced feature maps are feature maps representing feature vectors of the sample images;

a second comparing unit 1103, configured to compare the image features of the text strips with the enhanced feature maps to obtain predicted bounding boxes of the text strips on the enhanced feature maps.

With reference to FIG. 11, in some embodiments, the second comparing unit 1103 includes:

a second comparing subunit 11031, configured to compare the image features of the text strips with the enhanced feature maps for similarity to determine response regions of the text strips on the enhanced feature maps, where the response regions represent position regions of the text strips on the enhanced feature maps;

a third determining subunit 11032, configured to determine the predicted bounding boxes of the text strips on the enhanced feature maps according to the response regions of the text strips on the enhanced feature maps.

In some embodiments, the image features of the text strips include image features of pixels in the text strips, and the enhanced feature map includes feature vectors of pixels; The second comparing subunit 11031 is configured to compare the image features of the pixels in the text strips with feature vectors of pixels in the enhanced feature maps to obtain the response regions of the text strips on the enhanced feature maps.

In some embodiments, the second comparing subunit 11031 includes:

a third comparing module, configured to, for pixels in a text strip, compare image features of the pixels in the text strip with feature vectors of an enhanced feature map which correspond to the pixels in the text strip to obtain degrees of similarity;

a second determining module, configured to determine a response region of the text strip on the enhanced feature map according to the degrees of similarity.

In some embodiments, the second determining module includes:

a fifth determining sub-module, configured to determine a pixel whose degree of similarity is greater than a preset similarity threshold from the enhanced feature map according to the degrees of similarity;

a sixth determining sub-module, configured to determine the response region of the text strip on the enhanced feature map according to the determined pixel whose degree of similarity is greater than the preset similarity threshold.

In some embodiments, the pixel has a position attribute. The sixth determining sub-module is configured to determine the response region of the text strip on the enhanced feature map according to the position attribute of the pixel whose degree of similarity is greater than the preset similarity threshold in the enhanced feature map.

Correspondingly, the third determining subunit 11032 may be configured to perform image connected component processing on the response region of the text strips to generate a target bounding box of the text strip.

In some embodiments, the second comparing subunit 11031 includes:

a fourth comparing module, configured to, for any pixel in a text strip, compare an image feature of any pixel with feature vectors of pixels in an enhanced feature map for similarity respectively to obtain degrees of similarity;

a second generating module, configured to generate a response region of the text strip on the enhanced feature map according to the degrees of similarity.

In some embodiments, the second generating module includes:

a seventh determining sub-module, configured to determine a degree of similarity greater than a preset similarity threshold from the degrees of similarity;

an eighth determining sub-module, configured to determine, in the degrees of similarity greater than the preset similarity threshold, a degree of similarity of the corresponding pixel in the text strip with the feature vector of the same pixel;

a second generating sub-module, configured to generate the response region of the text strip on the enhanced feature map according to the degree of similarity of the same pixel.

In some embodiments, the pixel has a position attribute. The second generating sub-module may be configured to determine the response region of the text strip on the enhanced feature map according to the position attribute of the same pixel in the enhanced feature map.

Correspondingly, the third determining subunit 11032 may be configured to perform image connected component processing on the response region of the text strip to generate a target bounding box of the text strip on the enhanced feature map.

A training unit 1104 is configured to train a text detection model according to the predicted bounding boxes, where the text detection model is used to acquire a target bounding box of a to-be-recognized image.

FIG. 12 is a schematic diagram according to an eleventh embodiment of the present disclosure. As shown in FIG. 12, a text recognition apparatus 1200 provided by an embodiment of the present disclosure includes:

a third acquiring unit 1201, configured to acquire a to-be-recognized image;

a fourth acquiring unit 1202, configured to acquire a bounding box of the to-be-recognized image, where the bounding box includes a text strip, and the bounding box is acquired based on the method according to above embodiments of the text detection method, or the bounding box is acquired based on a preset text detection model, and the text detection model is generated by training based on the method according to above embodiments of the training method for a text detection model;

a recognizing unit 1203, configured to perform recognition processing on the bounding box to obtain text content of the to-be-recognized image.

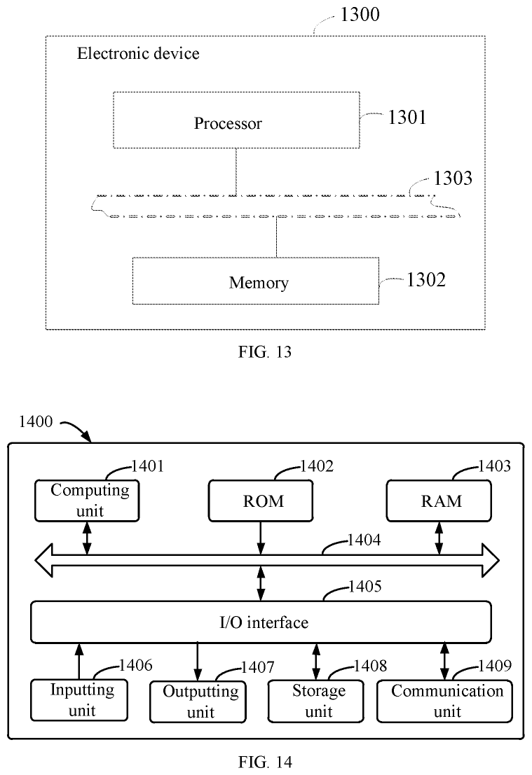

FIG. 13 is a schematic diagram according to a twelfth embodiment of the present disclosure. As shown in FIG. 13, an electronic device 1300 in the present disclosure may include: a processor 1301 and a memory 1302.

The memory 1302 is used to store programs. The memory 1302 may include a volatile memory (English: volatile memory), such as a random-access memory (English: random-access memory, abbreviation: RAM), e.g. a static random-access memory (English: static random-access memory, abbreviation: SRAM), a double data rate synchronous dynamic random access memory (English: Double Data Rate Synchronous Dynamic Random Access Memory, abbreviation: DDR SDRAM), etc. The memory may also include a non-volatile memory (English: non-volatile memory), such as a flash memory (English: flash memory). The memory 1302 is used to store computer programs (such as application programs, functional modules and the like for implementing the above methods), computer instructions, etc., and the above computer programs, computer instructions and the like can be stored in one or more memories 1302 in partitions. And the above-mentioned computer programs, computer instructions, data and so on may be called by the processor 1301.

The processor 1301 is configured to execute the computer program stored in the memory 1302, so as to implement steps in the methods involved in the above embodiments.

For details, reference can be made to the relevant descriptions in the above method embodiments.

The processor 1301 and the memory 1302 may be independent structures, or may be integrated together to form an integrated structure. When the processor 1301 and the memory 1302 are independent structures, the memory 1302 and the processor 1301 may be coupled and connected through a bus 1303.

The electronic device in this embodiment may implement the technical solutions in the above methods, and the specific implementation processes and technical principles thereof are the same and will be not repeated here.

According to embodiments of the present disclosure, the present disclosure also provides an electronic device, a readable storage medium and a computer program product.

According to an embodiment of the present disclosure, a computer program product is further provided. The computer program product includes a computer program, and the computer program is stored in a readable storage medium. At least one processor of an electronic device can read the computer program from the readable storage medium, and the at least one processor executes the computer program to cause the electronic device to execute the solution provided by any of the above embodiments.

FIG. 14 is a schematic block diagram of an example electronic device 1400 that can be used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may also represent various forms of mobile apparatuses, such as a personal digital assistant, a cellular phone, a smart phone, a wearable device, and other similar computing apparatuses. Components shown herein, connections and relationships thereof, as well as functions thereof are merely examples and are not intended to limit implementations of the present disclosure described and/or claimed herein.

As shown in FIG. 14, the device 1400 includes a computing unit 1401, which can perform various appropriate actions and processing based on a computer program stored in a read-only memory (ROM) 1402 or a computer program loaded from a storage unit 1408 to a random access memory (RAM) 1403. In the RAM 1403, various programs and data required for operations of the device 1400 can also be stored. The computing unit 1401, the ROM 1402 and the RAM 1403 are connected to each other through a bus 1404. An input/output (I/O) interface 1405 is also connected to the bus 1404.

Multiple components in the device 1400 are connected to the I/O interface 1405, including: an input unit 1406, such as a keyboard, a mouse, etc.; an output unit 1407, such as various types of displays, speakers, etc.; the storage unit 1408, such as a disk, an optical disc, etc.; and a communication unit 1409, such as a network card, a modem, a wireless communication transceiver, etc. The communication unit 1409 allows the device 1400 to exchange information/data with other devices through a computer network such as the Internet and/or various telecommunication networks.

The computing unit 1401 may be various general-purpose and/or special-purpose processing components with processing and computing capabilities. Some examples of the computing unit 1401 include, but are not limited to, a central processing unit (CPU), a graphics processing unit (GPU), various dedicated artificial intelligence (AI) computing chips, various computing units that run machine learning model algorithms, a digital signal processor (DSP), and any suitable processor, controller, microcontroller, etc. The computing unit 1401 executes the various methods and processing described above, for example, a text detection method, a training method for a text detection model, and a text recognition method. For example, in some embodiments, the text detection method, the training method for a text detection model, and the text recognition method may be implemented as a computer software program, which is tangibly contained in a machine-readable medium, such as the storage unit 1408. In some embodiments, part or all of computer program may be loaded and/or installed on the device 1400 via the ROM 1402 and/or the communication unit 1409. When the computer program is loaded into the RAM 1403 and executed by the computing unit 1401, one or more steps of the text detection method, the training method for a text detection model, and the text recognition method described above can be executed. Alternatively, in other embodiments, the computing unit 1401 may be configured to execute the text detection method, the training method for a text detection model, and the text recognition method in any other suitable manner (for example, by means of firmware).

The various implementations of the systems and technologies described herein can be implemented in a digital electronic circuit system, an integrated circuit system, a field programmable gate array (FPGA), an application specific integrated circuit (ASIC), an application-specific standard product (ASSP), a system on chip system (SOC), a complex programmable logic device (CPLD), computer hardware, firmware, software, and/or a combination thereof. These various embodiments may include: being implemented in one or more computer programs, where the one or more computer programs may be executed and/or interpreted on a programmable system including at least one programmable processor, and the programmable processor may be a dedicated or general-purpose programmable processor that can receive data and instructions from a storage system, at least one input apparatus and at least one output apparatus, and can transmit data and instructions to the storage system, the at least one input apparatus and the at least one output apparatus.

The program codes used to implement the methods of the present disclosure can be written in any combination of one or more programming languages. These program codes can be provided to processors or controllers of general-purpose computers, special-purpose computers, or other programmable data processing apparatuses, so that when the program codes are executed by the processors or controllers, the functions/operations specified in the flowcharts and/or block diagrams are implemented. The program codes can be entirely executed on a machine, partly executed on the machine, partly executed on the machine and partly executed on a remote machine as an independent software package, or entirely executed on the remote machine or server.

In the context of the present disclosure, a machine-readable medium may be a tangible medium, which may contain or store a program for use by an instruction execution system, apparatus or device or for use in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination of the foregoing. More specific examples of the machine-readable storage medium may include electrical connections based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

In order to provide interaction with a user, the systems and technologies described herein may be implemented on a computer, where the computer has: a display apparatus (e.g., a CRT (cathode ray tube) or LCD (liquid crystal display) monitor) for displaying information to the user; and a keyboard and a pointing apparatus (e.g., a mouse or a trackball), through which the user can provide inputs to the computer. Other types of apparatuses may also be used to provide interaction with the user; for example, a feedback provided to the user may be any form of sensing feedback (such as, visual feedback, auditory feedback, or tactile feedback); and the input from the user may be received in any form (including acoustic input, voice input, tactile input).

The systems and technologies described here may be implemented in a computing system (e.g., a data server) including a back-end component, or in a computing system (e.g., an application server) including a middleware component, or in a computing system (e.g., a user computer having a graphical user interface or a web browser, through which the user can interact with the implementations of the systems and technologies described herein) including a front-end component, or in a computing system including any combination of the back-end component, the middleware component or the front-end component. The components of the system may be interconnected via digital data communication (e.g., a communication network) in any form or medium. Examples of the communication network include: a local area network (LAN), a wide area network (WAN) and the Internet.

A computer system may include a client and a server. The client and the server are generally located far away from each other and usually interact with each other through a communication network. A relationship between the client and the server is generated by computer programs running on corresponding computers and having a client-server relationship between each other. The server may be a cloud server, also known as a cloud computing server or a cloud host, which is a host product in a cloud computing service system to solve the defects of difficulties in management and weak business scalability in a traditional physical host and virtual private server (“Virtual Private Server”, or VPS for short) services. The server may also be a server of a distributed system, or a server combined with a blockchain.

It should be understood that steps can be reordered, added or deleted for the various forms of processes shown above. For example, the steps recited in the present disclosure can be performed in parallel, in sequence or in different orders, as long as desired results of the technical solutions disclosed by the present disclosure can be realized, and there is no limitation herein.

The above specific implementations do not limit the protection scope of the present disclosure. It should be understood by those skilled in the art that various modifications, combinations, sub-combinations and substitutions may be made according to design requirements and other factors. Any modification, equivalent replacement, improvement and the like made within the spirit and principle of the present disclosure shall be included in the protection scope of the present disclosure.

What is claimed is:

1. A text detection method, comprising:
acquiring an image feature of a text strip in a to-be-recognized image; and
performing visual enhancement processing on the to-be-recognized image to obtain an enhanced feature map of the to-be-recognized image, wherein the enhanced feature map is a feature map representing a feature vector of the to-be-recognized image;
comparing the image feature of the text strip with the enhanced feature map for similarity to obtain a target bounding box of the text strip on the enhanced feature map.

2. The method according to claim 1, wherein the comparing the image feature of the text strip with the enhanced feature map for similarity to obtain the target bounding box of the text strip on the enhanced feature map comprises:
comparing the image feature of the text strip with the enhanced feature map for similarity to determine a response region of the text strip on the enhanced feature map, wherein the response region represents a position region of the text strip on the enhanced feature map;
determining the target bounding box of the text strip on the enhanced feature map according to the response region of the text strip on the enhanced feature map.

3. The method according to claim 2, wherein the image feature of the text strip comprises image features of pixels in the text strip; the enhanced feature map comprises feature vectors of pixels; the determining the target bounding box of the text strip on the enhanced feature map according to the response region of the text strip on the enhanced feature map comprises:
comparing the image features of the pixels in the text strip with the feature vectors of the pixels in the enhanced feature map for similarity to obtain the response region of the text strip on the enhanced feature map.

4. The method according to claim 3, wherein the comparing the image features of the pixels in the text strip with the feature vectors of the pixels in the enhanced feature map for similarity to obtain the response region of the text strip on the enhanced feature map comprises:
for the pixels in the text strip, comparing the image features of the pixels in the text strip with the feature vectors of the enhanced feature map which correspond to the pixels in the text strip to obtain degrees of similarity, and determining the response region of the text strip on the enhanced feature map according to the degrees of similarity.

5. The method according to claim 4, wherein the determining the response region of the text strip on the enhanced feature map according to the degrees of similarity comprises:
determining a pixel whose degree of similarity is greater than a preset similarity threshold from the enhanced feature map according to the degrees of similarity; and determining the response region of the text strip on the enhanced feature map according to the determined pixel whose degree of similarity is greater than the preset similarity threshold.

6. The method according to claim 5, wherein the pixel has a position attribute; the determining the response region of the text strip on the enhanced feature map according to the determined pixel whose degree of similarity is greater than the preset similarity threshold comprises:
determining the response region of the text strip on the enhanced feature map according to the position attribute of the determined pixel whose degree of similarity is greater than the preset similarity threshold in the enhanced feature map;
and the determining the target bounding box of the text strip on the enhanced feature map according to the response region of the text strip on the enhanced feature map comprises:
performing image connected component processing on the response region of the text strip to generate the target bounding box of the text strip.

7. The method according to claim 3, wherein the comparing the image features of the pixels in the text strip with the feature vectors of the pixels in the enhanced feature map for similarity to obtain the response region of the text strip on the enhanced feature map comprises:
for any pixel in the text strip, comparing an image feature of any pixel with the feature vectors of the pixels in the enhanced feature map for similarity respectively to obtain degrees of similarity, and generating the response region of the text strip on the enhanced feature map according to the degrees of similarity.

8. The method according to claim 7, wherein the generating the response region of the text strip on the enhanced feature map according to the degrees of similarity comprises:
determining a degree of similarity greater than a preset similarity threshold from the degrees of similarity; and determining, in the degree of similarity greater than the preset similarity threshold, a degree of similarity of the corresponding pixel in the text strip with a feature vector of a same pixel;
generating the response region of the text strip on the enhanced feature map according to the degree of similarity of the same pixel.

9. The method according to claim 8, wherein the pixel has a position attribute; the generating the response region of the text strip on the enhanced feature map according to the degree of similarity of the same pixel comprises:
determining the response region of the text strip on the enhanced feature map according to the position attribute of the same pixel in the enhanced feature map;
and the determining the target bounding box of the text strip on the enhanced feature map according to the response region of the text strip on the enhanced feature map comprises:
performing image connected component processing on the response region of the text strip to generate the target bounding box of the text strip on the enhanced feature map.

10. The method according to claim 1, wherein the acquiring the image feature of the text strip in the to-be-recognized image comprises:
acquiring an image feature of the to-be-recognized image, and determining an initial bounding box of the to-be-recognized image according to the image feature of the to-be-recognized image, wherein the initial bounding includes the text strip.

11. A training method for a text detection model, comprising:
acquiring image features of text strips in sample images; and performing visual enhancement processing on the sample images to obtain enhanced feature maps of the sample images, wherein the enhanced feature maps are feature maps representing feature vectors of the sample images;
comparing the image features of the text strips with the enhanced feature maps for similarity to obtain predicted bounding boxes of the text strips on the enhanced feature maps, and training a text detection model according to the predicted bounding boxes, wherein the text detection model is used to acquire a target bounding box of a to-be-recognized image.

12. The method according to claim 11, wherein the comparing the image features of the text strips with the enhanced feature maps for similarity to obtain the predicted bounding boxes of the text strips on the enhanced feature maps comprises:
comparing the image features of the text strips with the enhanced feature maps for similarity to determine response regions of the text strips on the enhanced feature maps, wherein the response regions represent position regions of the text strips on the enhanced feature maps;
determining the predicted bounding boxes of the text strips on the enhanced feature maps according to the response regions of the text strips on the enhanced feature maps.

13. The method according to claim 12, wherein the image features of the text strips comprise image features of pixels in the text strips; the enhanced feature maps comprise feature vectors of pixels; the comparing the image features of the text strips with the enhanced feature maps for similarity to determine the response regions of the text strips on the enhanced feature maps comprises:
comparing the image features of the pixels in the text strips with the feature vectors of the pixels in the enhanced feature maps for similarity to obtain the response regions of the text strips on the enhanced feature maps.

14. The method according to claim 13, wherein the comparing the image features of the pixels in the text strips with the feature vectors of the pixels in the enhanced feature maps for similarity to obtain the response regions of the text strips on the enhanced feature maps comprises:
for pixels in a text strip, comparing image features of the pixels in the text strip with feature vectors of a corresponding enhanced feature map which correspond to the pixels in the text strip to obtain degrees of similarity, and determining a response region of the text strip on the enhanced feature map according to the degrees of similarity.

15. The method according to claim 13, wherein the comparing the image features of the pixels in the text strips with the feature vectors of the pixels in the enhanced feature maps for similarity to obtain the response regions of the text strips on the enhanced feature maps comprises:
for any pixel in a text strip, comparing an image feature of any pixel with feature vectors of pixels in a corresponding enhanced feature map for similarity respectively to obtain degrees of similarity, and generating a response region of the text strip on the enhanced feature map according to the degrees of similarity.

16. A text recognition method, comprising:
acquiring a to-be-recognized image, and acquiring a bounding box of the to-be-recognized image, wherein the bounding box includes a text strip, and the bounding box is obtained based on the method according to claim 1;
performing recognition on the bounding box to obtain text content of the to-be-recognized image.

17. A text recognition method, comprising:
acquiring a to-be-recognized image, and acquiring a bounding box of the to-be-recognized image, wherein the bounding box includes a text strip, and the bounding box is obtained based on a preset text detection model, and the text detection model is generated by training based on the method according to claim 11;
performing recognition on the bounding box to obtain text content of the to-be-recognized image.

18. A text detection apparatus, comprising:
at least one processor; and
a memory communicatively connected to the at least one processor; wherein,
the memory stores instructions executable by the at least one processor, and the instructions are executed by the at least one processor, to cause the at least one processor to:
acquire an image feature of a text strip in a to-be-recognized image;
perform visual enhancement processing on the to-be-recognized image to obtain an enhanced feature map of the to-be-recognized image, wherein the enhanced feature map is a feature map representing a feature vector of the to-be-recognized image;
compare the image feature of the text strip with the enhanced feature map for similarity to obtain a target bounding box of the text strip on the enhanced feature map.

19. A training apparatus for a text detection model, comprising:
at least one processor; and
a memory communicatively connected to the at least one processor; wherein,
the memory stores instructions executable by the at least one processor, and the instructions are executed by the at least one processor, to cause the at least one processor to execute the method according to claim 11.

20. A text recognition apparatus, comprising:
at least one processor; and
a memory communicatively connected to the at least one processor; wherein,
the memory stores instructions executable by the at least one processor, and the instructions are executed by the at least one processor, to cause the at least one processor to:
acquire a to-be-recognized image.
acquire a bounding box of the to-be-recognized image, wherein the bounding box comprises a text strip, and the bounding box is acquired based on the method according to claim 1; or the bounding box is acquired based on a preset text detection model, and the text detection model is generated by training based on the following steps: acquiring image features of text strips in sample images; performing visual enhancement processing on the sample images to obtain enhanced feature maps of the sample images, wherein the enhanced feature maps are feature maps representing feature vectors of the sample images; comparing the image features of the text strips with the enhanced feature maps for similarity to obtain predicted bounding boxes of the text strips on the enhanced feature maps, and training a text detection model according to the predicted bounding boxes;
perform recognition processing on the bounding box to obtain text content of the to-be-recognized image.
